(19) United States
(12) Patent Application Publication
(10) Pub. No.: US 2008/0204605 A1
(43) Pub. Date: Aug. 28, 2008

(54) SYSTEMS AND METHODS FOR USING A REMOTE CONTROL UNIT TO SENSE TELEVISION CHARACTERISTICS

(76) Inventor: Leonard Tsai, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/680,356

(22) Filed: Feb. 28, 2007

(51) Int. Cl. H04N 5/44

(52) U.S. Cl. 348/734; 348/E05.001

(57) ABSTRACT

A system for sensing television characteristics comprises a display device, a speaker, a calibration manager, and a remote control unit, which has a light sensor, a microphone, a transmitter, and logic. The logic is configured to determine, based on the light sensor and the microphone, a value indicative of an amount of time that elapses between emission of sound from the speaker and a detection of the sound by the microphone. The transmitter is configured to transmit a wireless signal based on the value, and the calibration manager is configured to adjust a parameter of a television system based on the wireless signal.

### RELATED ART

The quality of various television characteristics is typically dependent on the environment in which a television is situated. For example, it is well-known that the dimensions and the overall configuration of a room can affect various sound characteristics, such as surround sound quality. In addition, a viewer's position with respect to a television can also have a relatively significant impact to the perceived video and/or audio characteristics of the television. For example, it is generally ideal for sound at the same instant in a movie or other television program to reach a viewer simultaneously when emitted from multiple speakers, and many television systems allow a user to manually adjust speaker position and speaker delay to achieve such an effect. Moreover, a user may spend vast amounts of time tediously adjusting speaker positions and/or delays in an effort optimize his or her listening environment.

In addition, many television systems allow a user to manually adjust video parameters, such as brightness and contrast. Unfortunately, many users find the process of manually setting and adjusting video and audio parameters to be difficult and/or burdensome, particularly when the user is unfamiliar with the television system or the parameters that affect picture or sound quality. Even if a user optimizes television parameters for one viewing position, the television parameters may not be optimized for other viewing positions. Thus, when a user changes viewing positions, such as when he or she changes seats, perceived video and/or audio quality may be diminished.

In an effort to alleviate some of the aforedescribed problems and difficulties, some television systems are designed to automatically adjust various parameters without the need of user input. However, as described above, optimization of various parameters may depend on viewing positions, which can change from time-to-time. Moreover, discovering a viewer's current position may be problematic making it difficult to adequately adjust at least some parameters in a desired manner.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating an exemplary embodiment of a television system.

FIG. 2 is a block diagram illustrating an exemplary embodiment of a remote control unit, such as is depicted in FIG. 1.

FIG. 3 is a flow chart illustrating an exemplary method for sensing an exemplary characteristic of a television system, such as is depicted in FIG. 1.

FIG. 4 is a block diagram illustrating an exemplary embodiment of a television system.

### DETAILED DESCRIPTION

The present disclosure generally pertains to television systems and methods that utilize remote control units to sense video or audio characteristics. In one exemplary embodiment, a television system comprises a remote control unit having a light sensor and a microphone that can be used to automatically calibrate at least one parameter of the television system. In this regard, the light sensor and microphone are used to measure at least one television characteristic, such as a time-of-flight for sound emitted from a speaker. It can be assumed that the remote control unit is at or close to a user's viewing position, and the characteristic is, therefore, measured from a perspective similar to that of the user. The remote control unit wirelessly transmits information indicative of the measured characteristic, and this information is used to automatically adjust a parameter of the television system in an effort to optimize the perceived performance of the television system.

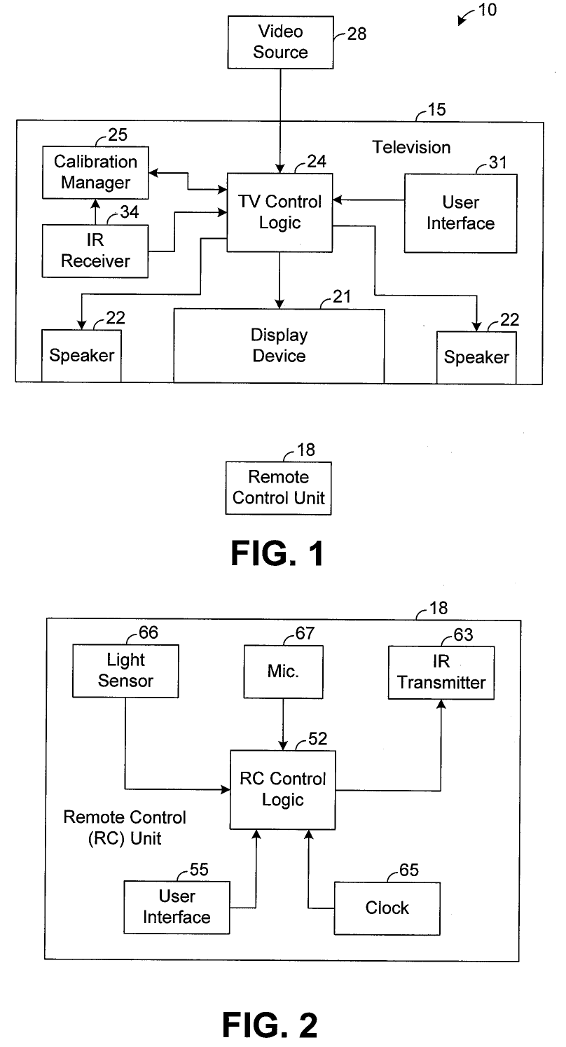

FIG. 1 depicts an exemplary television system 10 having a television 15 that can be controlled by a mobile remote control (RC) unit 18. In this regard, the television 15 has a display device 21, such as a cathode-ray tube, liquid crystal display (LCD), or other known or future-developed display device, for displaying video images to a user. The television 15 also has at least one speaker 22 for emitting sound. In the embodiment shown by FIG. 1, the television 15 has two speakers 22, a left speaker and a right speaker, although the television 15 may have any number of speakers 22 in other embodiments.

The television 15 also has control logic 24 for generally controlling the operation of the television 15, as will be described in more detail hereafter. In addition, a calibration manager 25 calibrates at least one parameter affecting perceived sound and/or video quality of the system 10. The television (TV) control logic 24 and the calibration manager 25 can be implemented in software, hardware, or a combination thereof. In one exemplary embodiment, the calibration manager 25, as well as portions of the control logic 24, are implemented in software and stored in memory (not specifically shown). When at least a portion of the control logic 24 or the calibration manager 25 is implemented in software, the television 15 comprises an instruction execution device (not specifically shown), such as a microprocessor, for executing instructions of the software.

The TV control logic 24 receives at least one television signal from a video source 28, such as cable, a satellite, a digital video disc (DVD) player, or a video cassette recorder (VCR). The received television signal comprises at least one video signal, which may be mixed with at least one audio signal and/or at least one other video signal. Based on channel selection information, such as may be received from a user interface 31 or the RC unit 18, the control logic 24 selects one of the video signals received from the video source 28 and transmits this signal to the display device 21, which displays a video image based on such signal. Also based on the channel selection information, the calibration manager 25 selects at least one audio signal and transmits the selected audio signal to the speakers 22, which emit sound based on such signal. Thus, using the interface 31 or the remote control unit 18, a user may enter channel selection information that is used to select a desired TV channel for viewing, similar to conventional television systems.

Note that the signals transmitted to and/or received from the TV control logic 24 may be digital or analog. Further, the components of the television 15 may be integrated to form a single unit. However, it is possible for any of the components to be non-integral with respect to any of the other components. For example, in one embodiment, the speakers 22 and display device 21 may be mounted on the same frame (not specifically shown) so that they are in fixed positions with respect to each other. In another example, the speakers 22 may be mounted separately from the display device 21 thereby enabling the speakers 22 to be moved with respect to the display device 21. Thus, a user may move the speakers 22 separate from the display device 21 in an effort to separately optimize audio and video characteristics of the television 15.

The RC unit 18 is configured to transmit wireless signals for controlling the operation of the television 15. In addition, the RC unit 18 may be configured to control operation of other media devices, such as compact disc (CD) players, DVD players, VCRs, etc. In the exemplary embodiment shown by FIG. 1, infrared (IR) signals are communicated by the RC unit 18, and the television has an IR receiver 34 for receiving such signals. However, in other embodiments, other types of signals may be used to transmit information from the RC unit 18 to the television 15.

As shown by FIG. 2, the RC unit 18 comprises control logic 52 for generally controlling the operation of the unit 18. The RC control logic 52 can be implemented in software, hardware, or a combination thereof. In one exemplary embodiment, the control logic 52 is implemented in software and stored in memory (not specifically shown). When at least a portion of the control logic 52 is implemented in software, the RC unit 18 comprises an instruction execution device (not specifically shown), such as a microprocessor, for executing instructions of the logic 52.

The RC unit 18 has a user interface 55, such as one or more buttons or switches, for receiving inputs from a user. Information indicative of such inputs may be wirelessly transmitted via an IR transmitter 63 to the television 15 of FIG. 1. For example, a user may enter, via interface 55, an input for selecting a television channel for viewing. In response to such input, the RC control logic 52 may transmit information indicative of the selected channel to the IR transmitter 63, which then transmits such information to the IR receiver 34 (FIG. 1) of the television 15. In response to such information, the TV control logic 24 may select video and audio signals from the video source 28 corresponding to the selected channel and provide such signals to the display device 21 and speakers 22, respectively. Thus, the TV program broadcast over the selected channel may be rendered by the television system 10.

As shown by FIG. 2, the RC unit 18 has a clock 65 for enabling the control logic 52 to track time, as will be described in more detail hereafter. The RC unit 18 also has a light sensor 66 and a microphone (mic.) 67, which can be used for calibrating the television system 10, as will be described in more detail hereafter. In this regard, the light sensor 66 and/or microphone 67 are used to measure at least one characteristic of the television system 10. The RC control logic 52 transmits information indicative of the measured characteristic to the television 15 of FIG. 1 via the IR transmitter 63 or some other type of transmitter (not shown). The calibration manager 25 (FIG. 1) then uses the received information to adjust at least one audio or video parameter of the television system 10.

As a mere example, conventional televisions have been known to adjust picture brightness based on ambient light conditions. In this regard, if the ambient light conditions are bright, then the picture brightness may be increased, but if the ambient light conditions are dim, then the picture brightness may be decreased. Moreover, a light sensor for measuring ambient brightness is typically mounted on or close to the same frame on which the television display device is mounted. Sometimes, the ambient conditions where a user is sitting may be quite different than the ambient light conditions at such display device. Thus, by sensing ambient light conditions at the RC unit 18 via light sensor 66, a better measurement of the ambient light conditions at or close to a user's viewing position is likely obtained since it is likely that the RC unit 18 is at a location close to the user's viewing location. Moreover, the light sensor 66 may sense ambient light, and a value indicative of the measured amount of light may be transmitted via IR transmitter 63 to the television 15. The calibration manager 25 may then adjust the brightness of the video image rendered by the display device 21 based on the measured brightness value in order to account for the ambient conditions sensed by the light sensor 66.

In another example, the time-of-flight of sound emitted from any of the speakers 22 may be estimated by the RC unit 18, and information indicative of the estimated flight time may be transmitted to the calibration manager 25. In one exemplary embodiment, light from the television 15 is used to mark the beginning of sound travel. For example, in one embodiment, the calibration manager 25 instructs the TV control logic 24 to transmit an audio signal, such as a tone within a specified frequency range, to one of the speakers 22, which converts the audio signal into sound. In addition to providing such an audio signal, the calibration manager 25 instructs the TV control logic 24 to transmit a particular video signal to the display device. In one example, the provided video signal causes the display device 21 to render the same color (e.g., white) for each pixel of at least one frame, although other types of signals may be used in other examples. Moreover, the calibration manager 25 controls the timing of the foregoing video signal and audio signal such that the display device 21 renders the video signal at the same time that the speaker 22 receives the audio signal and converts it into sound. Thus, in the current example, the video image rendered by the display device 21 transitions to an all white image at the beginning of sound emission by the speaker 22. In this regard, the transition of the video image marks the beginning of the sound emission.

The light sensor 66 senses light from the video image rendered by the display device 21, and the RC control logic 52 monitors the samples provided by the light sensor 66. In this regard, the control logic 52 compares each sample to a threshold. Moreover, when the video image rendered by the display device 21 is transitioned to mark the beginning of sound emission, the amount of light sensed by the light sensor 66 is increased causing the sensor's current sample to exceed the threshold. Thus, the RC control logic 52 detects the transition of the video image and, therefore, the beginning of sound emission when it determines that the current sample from the sensor 66 exceeds the threshold.

Since the video image rendered by the display device 21 travels at the speed of light, there is very little delay between the actual beginning of sound emission and the detected beginning of sound emission by the RC control logic 52. Thus, by tracking time since the detection of the beginning of sound emission until the emitted sound is detected via microphone 67, the RC control logic 52 can precisely estimate the flight time of sound between the speaker 22 and the remote control unit 18. Such information may be communicated to the calibration manager 25 and used to calibrate one or more television parameters. For example, the flight time of sound could be calculated for each speaker 22, and speaker delay settings may be adjusted based on the calculated flight times. As an example, an appropriate amount of delay for each speaker 22 may be automatically set such that, for all speakers 22, sound from the same instant in a movie or other television program arrives at the RC unit 18 at substantially the same time. Assuming that a user is holding the RC unit 18 or is otherwise close to the RC unit 18 during calibration, then such a calibration may help to optimize the user's listening environment.

In yet other examples, other television parameters may be calibrated based on the light sensor 66 and/or the microphone 67. For example, using at least one calculated flight time for at least one speaker 22, the user's distance from the display device 21 may be calculated. In this regard, a relatively accurate estimate can be calculated based on a single flight time measurement. However, a more accurate estimate may be calculated by averaging the flight times of more than one speaker, particularly if the positions of the speakers 22 are unknown. For example, two speakers 22 may be located on opposite sides of the display device 21. By averaging the flight times of the two speakers 22 and then estimating the viewer's distance based on the averaged flight time, then a more accurate estimate of the viewer's distance may be obtained. To determine the estimated distance, the average flight time may be multiplied by the expected rate of sound travel in order to estimate the viewer's distance from the display device 21. Alternatively, more complex algorithms, such as triangulation algorithms may be used to estimate the viewer's distance.

The estimated viewer's distance may be a factor in selecting at least one video parameter, such as brightness, contrast, etc., for the display device 21. As an example, the calibration manager 25 may store a table of different video parameter values for different viewing distances. Suitable parameters values may then be selected (e.g., interpolated) from such table depending on the estimated viewing distance. Further, since the rate of sound travel can be assumed to be relatively constant, the flight times themselves are indicative of distance, and conversion of flight times into distances is unnecessary. For example, a flight time rather than a distance may be used to look-up the appropriate video parameter from a parameter table.

Note that the selection of a suitable television parameter based on information from the sensor 66 or microphone 67 may be performed by either the calibration manager 25 or the RC control logic 52. For example, the calibration manager 25 at the television 15 may be configured to determine how information from the RC unit 18 is to be used to select a new television parameter for the television 15. In another embodiment, the RC control logic 52 may determine a new value of a television parameter, and transmit this value to the calibration manager 25, which then sets such parameter to the value received from the RC unit 18.

In addition, communication between the calibration manager 25 and the RC control logic 52 may be useful for coordinating the calibration process. For example, speaker identifiers may be communicated in order to identify which speaker 22 is being tested. If desired, wireless communication from the television 15 to the RC unit 18 may be enabled via IR some other form of communication. In one example, sound emitted from each speaker 22 is in a different frequency range such that the RC control logic 52 can identify each speaker based on the frequency of its emitted sound. In such an example, all speakers 22 can be tested simultaneously, if desired.

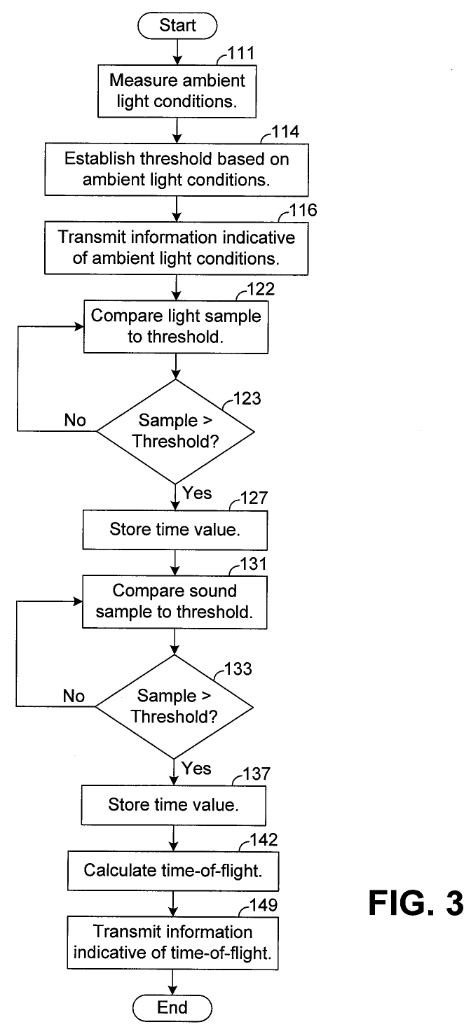

An exemplary method for calibrating at least one television parameter will be described hereafter with particular reference to FIG. 3. For illustrative purposes, the exemplary method will be described in the context of estimating the time-of-flight for sound emitted by one of the speakers. However, it should be apparent that other types of characteristics could be estimated in other examples.

Initially, a user grabs the RC unit 18 and then moves to a position where he or she intends to watch television 15. For example, the user may sit on a seat where he or she intends to remain while watching television 15. The user then provides an input, via user interface 55 (FIG. 2), indicating that calibration is to commence.

As shown by block 111 of FIG. 3, the light sensor 66 measures ambient light and transmits a value indicative of the measured ambient light to the RC control logic 52. As shown by block 114, The RC control logic 52 establishes a threshold based on the measured value received from the sensor 66. In this regard, the RC control logic 52 sets a threshold that is slightly higher than the measured value such that when the video image rendered by the display device 21 is transitioned, as will be described later, then the threshold is exceeded by a sample from the sensor 66. In addition, as shown by block 116, the RC control logic 52 transmits information indicative of the measured light value to the television 15 via IR transmitter 63 (FIG. 2). The transmitted message preferably indicates to the calibration manager 25 that a calibration process has been initiated. In addition, based on the measured light value, the calibration manager 25 may be configured to adjust at least one television parameter, such as the brightness of the display device 21.

As shown by blocks 122 and 123, the RC control logic 52 repetitively compares the current light sample from sensor 66 to the threshold established in block 114. Initially, the samples should be less than the threshold such that a “no” determination is repetitively made in block 123.

Upon receiving an indication from the RC unit 18 that a calibration process has been initiated, the calibration manager 25 instructs the TV control logic 24 to provide a video signal and an audio signal, respectively, to the display device 21 and one of the speakers 22 such that the video image rendered by the display device 21 transitions simultaneously with the emission of sound from the speaker 22 based on the audio signal. In one example, the video image transitions to an all white display, although other types of images are possible in other embodiments. Note that the transition may be brief. In one exemplary embodiment, the transitioned video image remains on the display device 21 for at least one sampling period of the light sensor 66.

Since the video image travels at the speed of light, light from the newly transitioned all white image reaches the light sensor 66 nearly simultaneous with the beginning of sound emission from the speaker 22. The light from the transitioned image (e.g., an all white display in the current example) is sufficient for causing the aforementioned threshold to be exceeded in block 123. Thus, the RC control logic 52 makes a “yes” determination in block 123 at about the same time that emission of sound from the speaker 22 begins.

As shown by block 127, the RC control logic 52 stores the current time value, as indicated by clock 65, in response to a “yes” determination in block 123. The RC control logic 52 then monitors the samples from the microphone 67. In this regard, the control logic 52 compares each sample to a predefined threshold, as shown by blocks 131 and 133, to determine when sound from the speaker 22 reaches the microphone 131. In this regard, the RC control logic 52 determines that such sound has reached the microphone 67 when the current sample from the microphone 67 exceeds the threshold. When this occurs, the RC control logic 52 stores the current time value from clock 65, as shown by block 137. As shown by block 142, the RC control logic 52 then calculates the speaker's time-of-flight (i.e., the time for sound to travel from the speaker 22 to the microphone 67) by subtracting the time value stored in block 127 from the time value stored in block 137. As shown by block 149, the RC control logic 52 transmits the calculated value to the calibration manager 25 via IR transmitter 63.

Based on the calculated flight time, the calibration manager 25 adjusts at least one television parameter. For example, the TV calibration manager 25 may adjust the speaker delay of at least one speaker 22. In another example, the calibration manager 25 may adjust a video parameter, such as brightness or contrast of the display device 21.

It should be noted that it is unnecessary for the transition of the video image marking the beginning of sound emission to occur simultaneously with the beginning of such sound emission. For example, the calibration manager 25 may be configured to initiate the video transition a predefined amount of time before initiating the sound emission. In such an embodiment, the control logic 52 may be configured to appropriately adjust the measured time between detection of the video transition and detection of sound. For example, if the calibration manager 25 is configured to initiate the video transition five seconds before sound emission, then the control logic 52 may be configured to subtract five seconds from the measured time period (i.e., between detection of the video transition and detection of sound) in order to determine the time-of-flight of the sound. Various other methodologies for determining the time-of-flight of the sound are possible in yet other examples.

In addition, various other changes to the embodiments specifically described herein are possible. For example, the calibration manager 25 may reside external to the television 15. As a mere example, the calibration manager 25 may reside in a set-top box (not shown) or in other locations in yet other embodiments.

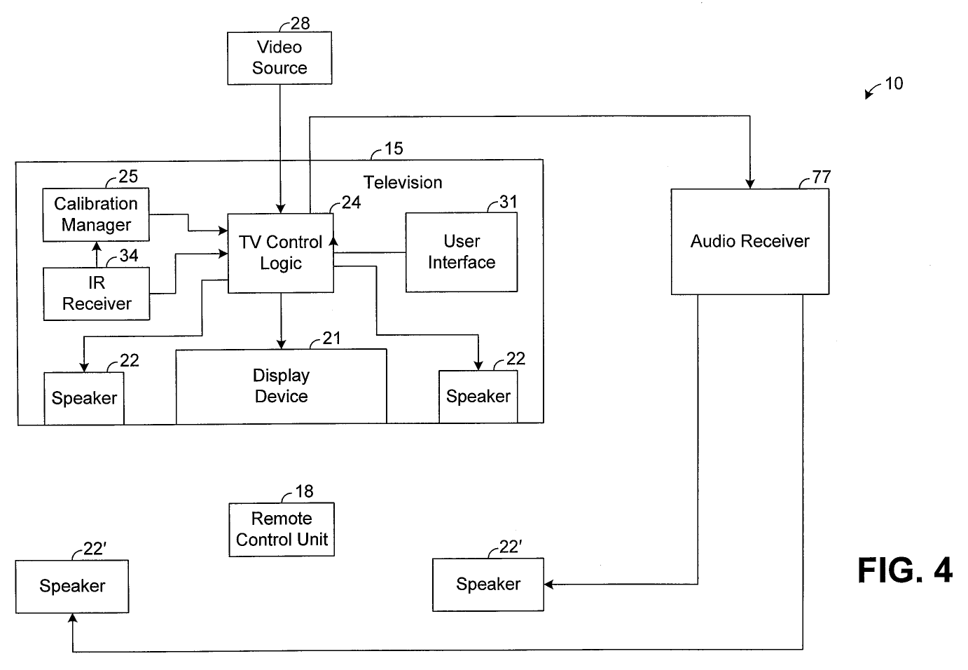

FIG. 4 shows an exemplary embodiment, in which an audio receiver 77 controls additional speakers 22′ separate from the television control logic 24. In this regard, the audio receiver 77 receives audio signals from the TV control logic 24 so that sound associated with the program being viewed can be emitted from the speakers 22′ in addition to or in lieu of the speakers 22. The speakers 22′ may be calibrated via the techniques similar to those described above for speakers 22. For example, the method shown by FIG. 3 may be repeated for each speaker 22 and 22′ so that the flight time for each speaker is determined. Based on such flight times, the speaker delay of one or more speakers 22 and 22′ may be appropriately adjusted such that differences in the measured flight times are accounted for in order to optimize sound quality. In the embodiment shown by FIG. 4, the TV control logic 24 is configured to communicate the desired audio parameters for speakers 22, as determined by the calibration manager 25, to the audio receiver 77.

In various examples described above, information is transmitted between the RC unit 18 and the television 15 via infrared signals, but other types of signals may be used in other embodiments. In addition, the beginning of sound emission is described above as being marked by a transition of the video image rendered by the display device 21. However, in other embodiments, other types of light may be used to mark the beginning of sound emission. For example, it is possible for the television 15 to have an optical transmitter, such as an IR transmitter. In such an example, light from such a transmitter may mark the beginning of sound emission similar to the way a transition of the video image of display device 21 is described above as marking the beginning of sound emission.

Further, if the remote control unit 18 is able to receive information from the calibration manager 25 (e.g., via IR signals), then the calibration manager 25 could specify when emission of sound from a speaker 22 is to commence. In such an embodiment, it would be unnecessary for light marking the beginning of sound emission to be transmitted simultaneously with the beginning of such sound emission. Moreover, it would be apparent to one of ordinary skill in the art that various changes and modifications may be made to the above-described embodiments.

Now, therefore, the following is claimed:

1. A remote control unit for a television system, comprising:
a light sensor configured to sense light from an image displayed by a remote television;
a microphone; and
logic configured to measure a sound characteristic of the television system based on the light sensed by the light sensor and sound sensed by the microphone, the logic further configured to transmit a wireless signal based on a measurement of the sound characteristic by the logic.

2. The television remote control unit of claim 1, wherein the sound characteristic is a time-of-flight for the sound.

3. The television remote control unit of claim 1, wherein the logic is configured to detect a transition in the image based on the light sensor and is configured to determine an amount of time that elapses between detection of the transition and sensing of the sound by the microphone.

4. The television remote control unit of claim 3, wherein the wireless signal comprises information indicative of the amount of time.

5. The television remote control unit of claim 3, wherein the logic is configured to detect the transition by comparing samples from the light sensor to a threshold.

6. A television system, comprising:
a display device;
a speaker;
a remote control unit having a light sensor, a microphone, a transmitter, and logic, the logic configured to determine, based on the light sensor and the microphone, a value indicative of an amount of time that elapses between emission of sound from the speaker and a detection of the sound by the microphone, the transmitter configured to transmit a wireless signal based on the value; and
a calibration manager configured to adjust a parameter of the television system based on the wireless signal.

7. The system of claim 6, wherein the parameter is an audio parameter.

8. The system of claim 6, wherein the parameter is a video parameter.

9. The system of claim 6, wherein the logic is configured to detect a beginning of the emission based on the light sensor.

10. The system of claim 6, wherein the display device is configured to display a video image, and wherein the logic is configured to detect a transition in the video image based on the light sensor and to detect a beginning of the emission in response to a detection of the transition.

11. The system of claim 10, wherein the logic is configured to detect the transition by comparing samples from the light sensor to a threshold.

12. A method for use in a television system, comprising:
emitting sound from a speaker;
marking a beginning of the emitting, the marking comprising emitting light;
sensing the light at a remote control unit of the television system;
sensing the sound at the remote control unit;
determining a time-of-flight for the sound based on each of the sensing steps; and
adjusting a parameter of the television system based on the determined time-of-flight.

13. The method of claim 12, further comprising rendering a video image based on the adjusted parameter.

14. The method of claim 12, further comprising emitting sound based on the adjusted parameter.

15. The method of claim 12, wherein the emitting the light and the emitting the sound are performed simultaneously.

16. The method of claim 12, wherein the light defines a video image.

17. The method of claim 16, further comprising detecting a transition in the video image, wherein the determining is based on the detecting.

18. The method of claim 17, wherein the determining comprises determining an amount of time that elapses between the detecting and the sensing the sound.
